(19) United States
(12) Patent Application Publication
(10) Pub. No.: US 2016/0115367 A1
(43) Pub. Date: Apr. 28, 2016

(54) Ultrahigh Molecular Weight Polyethylene Reinforced Rubber Compositions For Subterranean Applications

(71) Applicant: SCHLUMBERGER TECHNOLOGY CORPORATION, Sugar Land, TX (US)

(72) Inventor: Huilin Tu, Sugar Land, TX (US)

(21) Appl. No.: 14/890,135

(22) PCT Filed: May 8, 2014
(86) PCT No.: PCT/US2014/037315

§ 371 Date: Nov. 9, 2015

Related U.S. Application Data
(60) Provisional application No. 61/820,980, filed on May 8, 2013.

(51) Int. Cl. C09K 8/50

(52) U.S. Cl. CPC C09K 8/50

(57) ABSTRACT

An elastomeric compound having an elastomer matrix and a ultra high molecular weight filler material dispersed throughout the elastomer matrix. Mechanical and thermal manipulation of the elastomeric compound causes the ultra high molecular weight filler material to deform to have a higher aspect ratio, thereby increasing the mechanical strength of the elastomeric compound.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir. One piece of equipment which may be installed is the packer. The packer supports the completions equipment mechanically in the wellbore and provides fluid barrier between production zones within the well.

### SUMMARY

The present invention relates to using fillers of ultra-high molecular weight thermoplastic (UHMWTP) to reinforce elastomeric components, such as swellable rubbers for subterranean applications and processes to produce them. Some elastomers suffer decreases in modulus, hardness, elongation at break and tensile strength upon absorption of solvent. UHMWTP fillers improve the mechanical properties of elastomers. For swellable materials, this is true both for the virgin and swollen state. The UHMWTP filled swell compounds swell more than the control samples. In the swollen state, the hardness, modulus, elongation at break and tensile strength of the UHMWTP filled swell compounds improve. Better mechanical properties link directly to higher pressure differential ratings of swell packers, and the general strength and reliability of all affected elastomers.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

FIG. 1 shows a scanning electron microscopy image of an example of UHMWTP filler, MIPELON P-200, according to embodiments of the present disclosure.

FIG. 2 is a schematic illustration of a swell packer according to embodiments of the present disclosure.

FIG. 3 is a graph of the particle size of MIPELON products MIPELON PM-200 and XM-220 according to embodiments of the present disclosure.

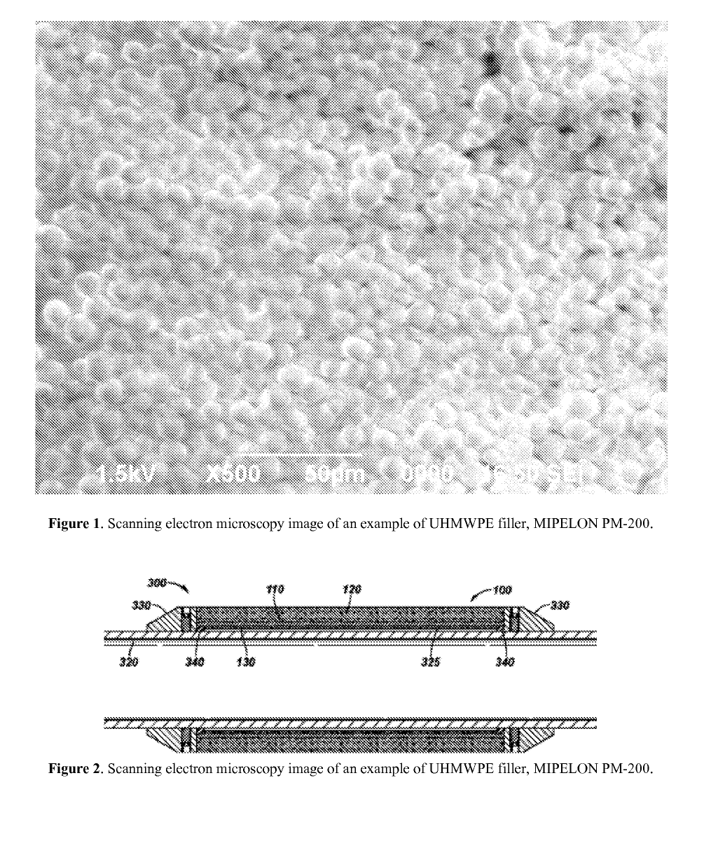

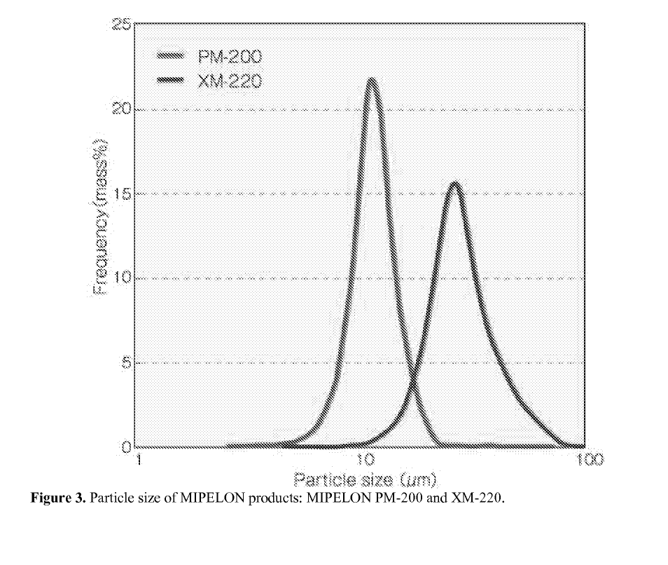

### DETAILED DESCRIPTION

In the following description, numerous details are set forth to provide an understanding of the present disclosure. However, it will be understood by those skilled in the art that the embodiments of the present disclosure may be practiced without these details and that numerous variations or modifications from the described embodiments may be possible.

The current invention disclosure describes UHMWTP reinforced rubber compositions for swell packer applications and processes to produce the same. Adding UHMWTP into swell rubber compositions improves the modulus and hardness of the virgin and swollen rubbers as well as tensile strength and elongation at break. In some embodiments the UHMWTP is an ultra high molecular weight polyethylene (UHMWPE) compound. In other embodiments the UHMWTP is an ultra high molecular weight polytetrafluoroethylene (UHMWPTFE) compound.

In various embodiments of the present disclosure, the elastomeric or rubber material can be EPDM, EPM, HNBR, NBR, NR, CR, ECO/CO, ACM, EVM, AEM, ACSM, VMQ, FVMQ, FKM, FEPM, FFKM and any appropriate blend. For embodiments in which the rubber compound is swellable, the swelling can be triggered by any suitable swelling mechanism, such as oil swell or brine swell.

The UHMWTP filler can be formed as small particles and mixed into a rubber matrix. In some embodiments, a surface finish/coating on the UHMWTP fillers affects the interactions between fillers and the rubber matrix and thus the mechanical properties of the filler reinforced rubber. The fillers can be used without any surface treatment. The native functional groups on the surface of fillers are capable of forming favorable interactions with certain polymers. In some embodiments, the fillers are treated with covering agents or coupling agents which enable strong interactions between the polymer matrix and fillers. The surface treatment agents include but are not limited to silane molecules containing alkyl, acryloxy, methacryloxy, epoxy, mercapto groups. Examples of such silanes are γ-methacryloxypropyltrimethoxysilane, γ-acryloxypropyltrimethoxysilane, hexadecyl-trimethoxysilane, mercaptoproyltrimethoxysilane, 3-glycidoxypropyltrimethoxysilane, bis(triethoxysilylpropyl)tetrasufide (TESPT), 3-thiocyanatopropyl-triethoxysilane (TCPTS), bis-(dimethylethoxysilylpropyl)tetrasulfide (DMESPT).

In some embodiments, the particle geometry is spherical and the diameter of the particle is in the range of 1-100 μm. The average particle size of the UHMWTP particle used in the example 1 and 2, MIPELON PM-200 is 10 μm (FIG. 2). Other sizes are possible as well. The average size of MIPELON XM-220 as shown FIG. 2 is around 30 μm, and it is also a suitable filler. The particles do not need to be perfectly spherical. Other particle shapes such as rod, disks and ellipsoid are also suitable.

In some embodiments, the UHMWTP filler loading is in the range of 1-50 phr. In other embodiments, the filler loading is in the range of 1-20 phr. Peroxide cure and sulfur cure systems are both suitable. A broad range of curatives are useful. Examples of peroxide curatives include but are not limited to 2,4-dichlorobenzoyl peroxide (DCBP), dibenzoyl peroxide (BP-50), dicumyl peroxide (DCP), 2,5-bis(tert-butylperoxy) 2,5-dimethyl-hexane (DBPH), di(4-methylbenzoyl) peroxide, Tert-butyl peroxybenzoate, di(tertbutylperoxyisopropyl)benzene, di-tert-butyl peroxide. In some embodiments, the sulfur curatives are element sulfur and sulfur donor cure systems with accelerators. Common accelerators include MBS, MBT, MBTS, TETD, TMTD, TMTM, ZBDC, ZBPD etc.

The compounds of UHMWTP filler reinforced elastomers can be mixed using internal mixer or two roll mills. The rubbers are calendared using two roll mills. The UHMWTP filler reinforced swell rubbers are bonded and supported on a metal mandrel or sleeve to form the swell packer element. In certain applications, bonding the rubber to the metal mandrel or sleeve is not required. Transfer molding, compression molding and mandrel wrapping are all suitable manufacturing methods to produce swell packers of ultra-high molecular weight polyethylene reinforced swell rubbers. Other elastomers are manufactured with different processes according to the needs of the given application. The fillers are introduced during early stages of manufacture and as such can be uniformly dispersed throughout the elastomer. The mechanical manipulation causes some degree of deformation in the elastomer, causing the filler particles to change shape from initially generally spherical pellets into elongated shapes. The aspect ratio of the original shape is approximately 1:1, and final shape of the individual filler particles can be between 5:1 and 15:1. In some embodiments the filler particles have a final shape that is elongated in a major direction, and also in a transverse direction to a lesser degree, giving the particles a final shape approximating a flattened disk.

In some embodiments, the mechanical deformation and manufacture of the elastomers is performed at an elevated temperature. The temperature can be less than a melting temperature of the filler particles, but high enough to soften the filler particles to promote deformation. Different filler particles have different melting temperatures. For example, PTFE generally has a higher melting temperature than PE and accordingly the manufacture of elastomers having PTFE fillers is done at a higher temperature than an elastomer having PE filler particles. This may also yield an elastomer with a higher temperature rating as a finished product, factoring in the higher temperature threshold of the PTFE. Of course, other filler particles may also be used.

TABLE 1
Formulation 1

| | Control1 | Formulation 1 |
|---|---|---|
| Polymers | 130 | 130 |
| Carbon black | 50 | 50 |
| MIPELON PM-200 | 0 | 15 |
| Other additives | 37 | 37 |
| Curative | 5 | 5 |

TABLE 2
Physical properties of virgin coupons tested per
ASTM standards D2240 and D412.

| | Control 1 | Formulation 1 |
|---|---|---|
| Durometer (Shore A) | 71 | 75 |
| Tensile Strength (psi) | 3037 | 3162 |
| Elongation at Break (%) | 342 | 386 |
| 50% Modulus (psi) | 513 | 692 |

TABLE 3
Physical properties of oil swollen samples (aged in Conosol 200
for 24 hours) tested per ASTM standards D2240 and D412.

| Rubber | Control 1 | Formulation 1 |
|---|---|---|
| Durometer (Shore A) | 41 | 48 |
| Volume Swell (%) | 144 | 159 |
| Tensile Strength (psi) | 277 | 328 |
| Elongation at Break (%) | 136 | 143 |
| 50% Modulus (psi) | 141 | 186 |

TABLE 4
Formulation 2

| Rubber | Control 2 | Formulation 2 |
|---|---|---|
| Polymers | 100 | 100 |
| Carbon black | 60 | 60 |
| MIPELON PM-200 | 0 | 20 |
| Other additives | 10 | 10 |
| Curative | 4 | 4 |

TABLE 5
Mechanical properties of virgin coupons tested per
ASTM standards D2240 and D412.

| Rubber | Control 2 | Formulation 2 |
|---|---|---|
| Durometer (Shore A) | 81 | 85 |
| Tensile Strength (psi) | 3527 | 3356 |
| Elongation at Break (%) | 255 | 264 |
| 50% Modulus (psi) | 1521 | 1585 |

TABLE 6
Physical properties of oil swollen samples (aged in Conosol 200
at 220° F. for 70 hours) tested per ASTM standards D2240 and D412.

| Rubber | Control 2 | Formulation 2 |
|---|---|---|
| Durometer (Shore A) | 56 | 65 |
| Volume Swell (%) | 150 | 157 |
| Tensile Strength (psi) | 512 | 843 |
| Elongation at Break (%) | 82 | 94 |
| 50% Modulus (psi) | 466 | 814 |

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the disclosure.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. An elastomeric component for a downhole tool comprising:
an elastomer matrix; and
ultra high molecular weight thermoplastic filler particles dispersed throughout the elastomer matrix, wherein the ultra high molecular weight thermoplastic filler particles have a first aspect ratio when introduced into the elastomer matrix, and wherein deformation of the elastomer matrix during manufacture of the elastomeric component causes the ultra high molecular weight thermoplastic filler particles to deform to have a second aspect ratio higher than the first aspect ratio.

2. The elastomeric component of claim 1 wherein the first aspect ratio is approximately 1:1, and the second aspect ratio is between 5:1 and 15:1.

3. The elastomeric component of claim 1 wherein the ultra high molecular weight thermoplastic filler particles are ultra high molecular weight polyethylene.

4. The elastomeric component of claim 1 wherein the ultra high molecular weight thermoplastic filler particles are ultra high molecular weight polytetrafluoroethylene.

5. The elastomeric component of claim 1 wherein the elastomeric component is a swellable elastomeric component.

6. The elastomeric component of claim 1 wherein individual particles of the ultra high molecular weight thermoplastic filler particles are between 1-100 μm in diameter as measured at the first aspect ratio.

7. The elastomeric component of claim 1 wherein the ultra high molecular weight thermoplastic filler comprises MIPELON P-200 or MIPELON XM-220.

8. The elastomeric component of claim 1 wherein the ultra high molecular weight thermoplastic filler is initially spherical in shape.

9. The elastomeric component of claim 1 wherein the ultra high molecular weight thermoplastic filler is initially rod-shaped.

10. The elastomeric component of claim 1 wherein the ultra high molecular weight thermoplastic filler is initially disk-shaped.

11. The elastomeric component of claim 1 wherein the ultra high molecular weight thermoplastic filler is initially ellipsoid in shape.

12. A method of manufacturing an elastomeric component for a downhole tool, the method comprising:
combining an elastomeric matrix with an ultra high molecular weight filler material to form a composite elastomer;
mechanically deforming the composite elastomer at a temperature lower than a melting temperature of the ultra high molecular weight filler material, but high enough to soften the ultra high molecular weight filler material to promote deformation of the ultra high molecular weight filler material to increase an aspect ratio of particles of the ultra high molecular weight filler material.

13. The method of claim 12, further comprising dispersing the ultra high molecular weight filler material throughout the elastomeric matrix.

14. The method of claim 12, further comprising combining at least one other filler material into the elastomeric matrix.

15. The method of claim 12, further comprising coupling the composite elastomer with a support member to form a packer wherein the composite elastomer comprises a sealing element of the packer.
